(19) United States
(12) Patent Application Publication
(10) Pub. No.: US 2012/0224546 A1
(43) Pub. Date: Sep. 6, 2012

(54) METHOD AND TERMINAL FOR PERFORMING DIRECT COMMUNICATION BETWEEN TERMINALS

(75) Inventors: Sung Cheol CHANG, Daejeon (KR); Mi-Young Yun, Daejeon (KR); Young-Ho Jung, Goyang-si (KR); Eunkyung Kim, Daejeon (KR); Sung Kyung Kim, Daejeon (KR); Won-Ik Kim, Daejeon (KR); Hyun Lee, Daejeon (KR); Chul Sik Yoon, Seoul (KR); Kwang Jae Lim, Daejeon (KR)

(73) Assignee: ELECTRONICS AND TELECOMMUNICATIONS RESEARCH INSTITUTE, Daejeon (KR)

(21) Appl. No.: 13/412,585

(22) Filed: Mar. 5, 2012

(30) Foreign Application Priority Data
Mar. 4, 2011 (KR) 10-2011-0019674
May 19, 2011 (KR) 10-2011-0047403
Jul. 11, 2011 (KR) 10-2011-0068540
Sep. 9, 2011 (KR) 10-2011-0092067
Mar. 5, 2012 (KR) 10-2012-0022309

(51) Int. Cl. H04W 72/04

(52) U.S. Cl. 370/329

(57) ABSTRACT

A first terminal for performing direct communication between terminals includes: a radio frequency (RF) unit; and a processor, the processor being adapted to perform direct communication with at least one second terminal by using resources allocated for direct communication between terminals, wherein the resources are divided into a first slot region and a second slot region, the first slot region including a synchronization channel containing synchronization information for direct communication between terminals, a dedicated channel for transmitting direct communication data between terminals, and a supplementary channel one-to-one mapped with the dedicated channel, and the second slot region including the dedicated channel and the supplementary channel.

This application claims priority to and the benefit of Korean Patent Application Nos. 10-2011-0019674, 10-2011-0047403, 10-2011-0068540, 10-2011-0092067, and 10-2012-0022309 filed in the Korean Intellectual Property Office on Mar. 4, 2011, May 19, 2011, Jul. 11, 2011, Sep. 9, 2011, and Mar. 5, 2012, respectively, the entire contents of which are incorporated herein by reference.

### BACKGROUND OF THE INVENTION

(a) Field of the Invention

The present invention relates to a method for performing direct communication between terminals, and a terminal supporting the same.

(b) Description of the Related Art

Methods for supporting direct communication between terminals by using resources allocated for cellular communication include a method of allocating some of resources for cellular communication as dedicated resources for inter-terminal direct communication for terminals within a cell coverage, and a method of simultaneously using resources for cellular communication for both cellular communication and direct communication.

Direct communication between terminals within the cell coverage of a base station is assumed. Moreover, it is assumed that a terminal intending to perform direct communication between terminals is able to know the location information of resources used for direct communication between terminals via a control channel of cellular communication.

However, there is a possibility that, under a disaster environment, some or all of terminals intending to perform direct communication may be located outside the cell coverage of the base station. In this case, the terminals located outside the cell coverage of the base station cannot receive the control channel of the base station. These terminals cannot obtain information about resources used for direct communication between terminals.

To solve this problem, a method for efficiently allocating resources used for direct communication between terminals is needed.

### SUMMARY OF THE INVENTION

The present invention has been made in an effort to provide a method for allocating resources used for direct communication between terminals. An exemplary embodiment of the present invention provides a method for a first terminal to perform direct communication between terminals, the method including performing direct communication with at least one second terminal by using resources allocated for direct communication between terminals, the resources including a common direct mode zone which is commonly allocated to all cells and has a fixed size and position.

The resources may further include a cell-specific direct mode zone which is allocated to each cell.

Information about the cell-specific direct mode zone may be acquired through the common direct mode zone.

The common direct mode zone may be allocated to part of an uplink area of resources allocated for cellular communication.

The common direct mode zone resources may be allocated to four contiguous PRUs (physical resource units).

The four contiguous PRUs may have the four highest PRU indices.

A basic unit of the common direct mode zone may include a plurality of resource blocks.

The plurality of resource blocks may be distributed in a frequency domain.

The resources may further include common direct mode zone extended which is commonly allocated to all cells and has a fixed size and position.

The common direct mode zone extended may be allocated to part of a downlink area of resources allocated for cellular communication.

An exemplary embodiment of the present invention provides a method for a first terminal to perform direct communication between terminals, the method including performing direct communication with at least one second terminal by using resources allocated for direct communication between terminals, wherein the resources include a first slot region and a second slot region, the first slot region including at least one of a synchronization channel containing synchronization information for direct communication between terminals, a dedicated channel for transmitting direct communication data between terminals, and a supplementary channel one-to-one mapped with the dedicated channel, the second slot region including the dedicated channel and the supplementary channel.

The synchronization channel may include a first region for transmitting information for acquiring frequency synchronization and time synchronization, and a second region for transmitting at least one of hop count information, base station information, transmitting terminal information, receiving terminal information, and frame structure information.

The supplementary channel may transmit at least one of an indicator of a MAC message, PHY signaling, and a feedback message.

The dedicated channel may include a plurality of dedicated subchannels, the supplementary channel may include a plurality of supplementary subchannels, and each of the dedicated subchannels may be one-to-one mapped with each of the supplementary subchannels.

A supplementary subchannel corresponding to a dedicated subchannel allocated to the first slot region may be allocated to the second slot region, and a supplementary subchannel corresponding to a dedicated subchannel allocated to the second slot region may be allocated to the first slot region.

An exemplary embodiment of the present invention provides a method for a first terminal to perform direct communication between terminals, the method including performing direct communication with at least one second terminal by using resources allocated for direct communication between terminals, wherein the resources are included in a resource area including a plurality of superframes, each superframe including a plurality of frames, each frame including a plurality of subframes, wherein a synchronization channel containing synchronization information for direct communication between terminals, a dedicated channel for transmitting direct communication data between terminals, and a supplementary channel one-to-one mapped with the dedicated channel may be respectively allocated to the subframes.

Each superframe includes a first slot region and a second slot region, the first slot region including at least one of the synchronization channel, the dedicated channel, and the supplementary channel, and the second slot region including the dedicated channel and the supplementary channel.

The first subframe of the first slot region may be allocated to the synchronization channel.

The dedicated channel may be allocated in units of dedicated subchannels, each including a plurality of resource blocks, and the supplementary channel may be allocated in units of supplementary subchannels, each including a plurality of mini-tiles.

A dedicated subchannel allocated to the first slot region may be mapped with one of the supplementary subchannels allocated to the second slot region, and a dedicated subchannel allocated to the second slot region may be mapped with one of the supplementary subchannels allocated to the first slot region.

A plurality of resource blocks constituting the dedicated subchannel may be distributed in a frequency domain, and a plurality of mini-tiles constituting the supplementary subchannel may be distributed in a frequency domain. The plurality of resource blocks constituting the dedicated subchannel may be distributed in the frequency domain by a cyclic shift or permutation sequence.

The plurality of mini-tiles constituting the supplementary subchannel may be distributed in the frequency domain according to a result of a modulo operation of the mini-tile indices.

An exemplary embodiment of the present invention provides a method for a first terminal to perform direct communication between terminals, the method including performing direct communication with at least one second terminal by using resources allocated for direct communication between terminals, wherein the resources include at least one of a synchronization channel for transmitting synchronization information for direct communication between terminals, a dedication channel for transmitting direct communication data between terminals, and a contention channel for acquiring the right of use of the dedicated channel.

The synchronization information may include at least one of information required for acquiring frequency synchronization or time synchronization between terminals, hop count information, base station information, transmitting terminal information, receiving terminal information, and frame structure information.

The synchronization channel may be allocated over the entire frequency domain allocated to the resources.

The contention channel may be transmitted through CSMA-CA (carrier sense multiple access with collision avoidance).

A basic unit of the resources may include a plurality of resource blocks.

An exemplary embodiment of the present invention provides a first terminal for performing direct communication between terminals, the first terminal including a radio frequency (RF) unit and a processor, the processor being adapted to perform direct communication with at least one second terminal by using resources allocated for direct communication between terminals, wherein the resources are commonly allocated to all cells and have a fixed size and position.

An exemplary embodiment of the present invention provides a first terminal for performing direct communication between terminals, the first terminal including a radio frequency (RF) unit and a processor, the processor being adapted to perform direct communication with at least one second terminal by using resources allocated for direct communication between terminals, wherein the resources are divided into a first slot region and a second slot region, each slot region including a synchronization channel containing synchronization information for direct communication between terminals, a dedicated channel for transmitting direct communication data between terminals, and a supplementary channel one-to-one mapped with the dedicated channel.

An exemplary embodiment of the present invention provides a first terminal for performing direct communication between terminals, the first terminal including a radio frequency (RF) unit and a processor, the processor being adapted to perform direct communication with at least one second terminal by using resources allocated for direct communication between terminals, wherein the resources are included in a resource area including a plurality of superframes, each superframe including a plurality of frames, each frame including a plurality of subframes, wherein a synchronization channel containing synchronization information for direct communication between terminals, a dedicated channel for transmitting direct communication data between terminals, and a supplementary channel one-to-one mapped with the dedicated channel may be respectively allocated to the subframes.

An exemplary embodiment of the present invention provides a first terminal for performing direct communication between terminals, the first terminal including a radio frequency (RF) unit and a processor, the processor being adapted to perform direct communication with at least one second terminal by using resources allocated for direct communication between terminals, wherein the resources include at least one of a synchronization channel for transmitting synchronization information for direct communication between terminals, and a contention channel for acquiring the right of use of the dedicated channel.

### BRIEF DESCRIPTION OF THE DRAWINGS

FIG. 1 is a view showing an environment supporting direct communication between terminals according to an exemplary embodiment of the present invention.

FIG. 2 is a flowchart showing a method of allocating resources for direct communication between terminals according to an exemplary embodiment of the present invention.

FIGS. 3 to 5 show a frame structure in which resources for direct communication between terminals are allocated according to an exemplary embodiment of the present invention.

FIG. 6 shows a frame structure in which resources for direct communication between terminals are allocated according to another exemplary embodiment of the present invention.

FIG. 7 to FIG. 9 are tables showing a method for allocating common direct mode zone to PRUs according to an exemplary embodiment of the present invention.

FIG. 10 is a view showing a frame structure according to an exemplary embodiment of the present invention.

FIG. 11 to FIG. 14 are views showing a resource dividing method according to an exemplary embodiment of the present invention.

FIG. 15 is a view showing a frame structure according to another exemplary embodiment of the present invention.

FIG. 16 is a view concretely showing a frame structure including common direct mode zone among resources for direct communication between terminals according to another exemplary embodiment of the present invention.

FIG. 17 to FIG. 20 are views showing a resource dividing method according to another exemplary embodiment of the present invention.

FIG. 21 is a view showing a method for mapping a dedicated channel and a supplementary channel according to an exemplary embodiment of the present invention.

FIG. 22 is a view showing a method for mapping a dedicated channel and a supplementary channel according to another exemplary embodiment of the present invention.

FIG. 23 is a view showing a method for mapping a dedicated channel and a supplementary channel according to yet another exemplary embodiment of the present invention.

FIG. 24 is a view showing a method for mapping a dedicated channel and a supplementary channel according to still another exemplary embodiment of the present invention.

FIG. 25 is a view showing a method for mapping a dedicated channel and a supplementary channel according to a further exemplary embodiment of the present invention.

FIG. 26 shows a method for mapping a plurality of mRBs constituting each dedicated subchannel according to an exemplary embodiment of the present invention.

FIG. 27 shows a method for mapping a plurality of mRBs constituting each dedicated subchannel according to another exemplary embodiment of the present invention.

FIG. 28 shows a method for mapping a plurality of mRBs constituting each dedicated subchannel according to yet another exemplary embodiment of the present invention.

FIG. 29 illustrates a terminal applicable to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the specification, a mobile station (MS) may indicate a terminal, a mobile terminal (MT), a subscriber station (SS), a portable subscriber station (PSS), an access terminal (AT), and user equipment (UE), and may include entire or partial functions of the terminal, the mobile terminal, the subscriber station, the portable subscriber station, the access terminal, and the user equipment.

In the specification, a base station (BS) may indicate a nodeB (Node-B), an evolved Node-B (eNB), an access point (AP), a radio access station (RAS), a base transceiver station (BTS), and a mobile multihop relay (MMR)-BS, and it may include entire or partial functions of the nodeB, the eNB, the access point, the wireless radio access station, the base transceiver station, and the MMR-BS.

In this specification, a method of fixing resources used for direct communication between terminals regardless of base station is considered. To this end, there is a need for a concrete method for simultaneously allocating the same physical resources to all base stations without affecting the operation of a legacy terminal if a new system (e.g., IEEE 802.16n) has to support terminals (hereinafter referred to as legacy terminals) of a legacy system (e.g., IEEE 802.16m).

A specific base station under a disaster environment has a large number of terminals which intend to perform direct communication between terminals. Thus, more and more resources are needed to be allocated for direct communication between terminals. Also, in the case of direct communication between terminals outside a cell coverage, there is no interference to a terminal or base station in a cellular mode. Therefore, more resources for direct communication between terminals outside the cell coverage may be allocated, compared to resources for direct communication between terminals within the cell coverage. Accordingly, there is a need for a method for allocating more resources for direct communication between terminals, as well as resources allocated regardless of base station, to each base station,

In this specification, description will be given based on a frame structure according to IEEE 802.16m. That is, a superframe includes a plurality of frames, and each frame includes at least one downlink (DL) subframe and at least one uplink (UL) subframe. For example, a superframe may include four frames, and each frame may include five DL subframes and three UL subframes. While an example of a legacy frame is a sequential arrangement of five DL subframes and three UL subframes in each frame, an example of a new frame is a sequential arrangement of three DL frames, three UL subframes, and two DL subframes.

This aspect is merely an example for convenience of description, and the technical idea of the present invention can be applied to various types of frame structures.

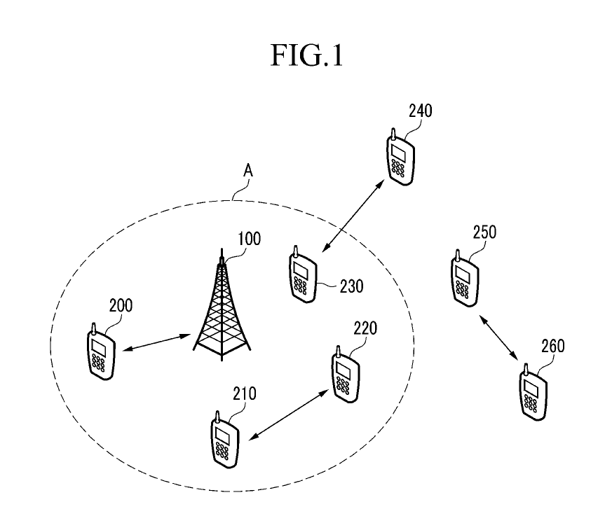

FIG. 1 is a view showing an environment supporting direct communication between terminals according to an exemplary embodiment of the present invention.

Referring to FIG. 1, at least one terminal 200, 210, 220, 230, 240, 250, or 260 may be located within or outside the cell coverage A of a base station 100.

A terminal 200 within the cell coverage A may perform cellular communication with the base station 100, or direct communication can be performed between terminals 210 and 220. Also, direct communication may be performed between a terminal 230 within the cell coverage A and a terminal 240 outside the cell coverage A. Moreover, direct communication may be performed even between terminals 250 and 260 outside the cell coverage A.

A method of allocating resources for direct communication between terminals according to an exemplary embodiment of the present invention will be described hereinbelow.

Resources for direct communication between terminals according to an exemplary embodiment of the present invention may be classified into a common direct mode resource (Common Direct Mode Zone, CDMZ) and a cell-specific direct mode resource (CellpSpecific Direct Mode Zone, CSDMZ). Herein, the common direct mode zone is resource which are commonly allocated for a predetermined size and position regardless of base station. The cell-specific direct mode zone is resource which is adaptively allocated to each base station by taking the amount of resources used for cellular communication and the demand for direct communication between terminals into consideration.

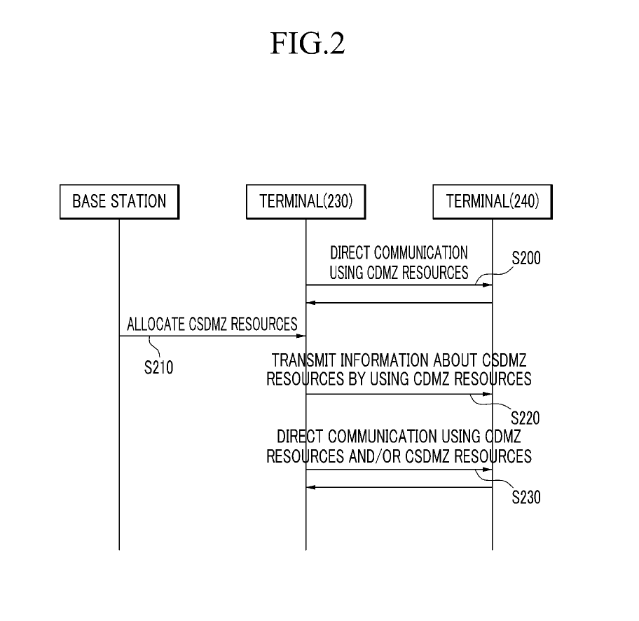

FIG. 2 is a flowchart showing a method of allocating resources for direct communication between terminals according to an exemplary embodiment of the present invention. It is assumed that the terminal 230 and the terminal 240 are already aware of information about the common direct mode zone.

Referring to FIG. 2, the terminal 230 performs direct communication with the terminal 240 by using the common direct mode zone (S200).

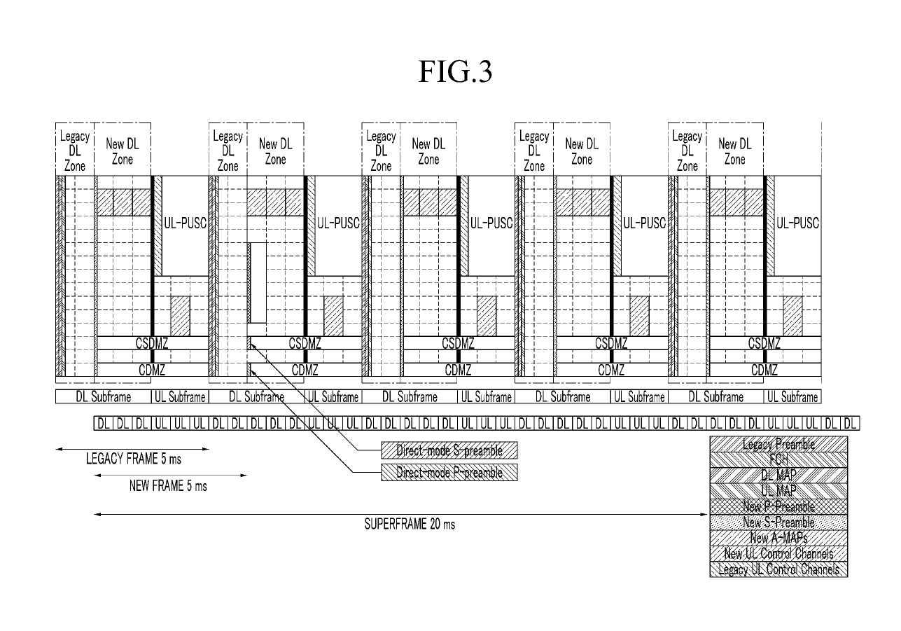

If the terminal 230 is allocated the cell-specific direct mode zone from the base station 100 (S210), the terminal 230 transmits information about the cell-specific direct mode zone to the terminal 240 (S220). At this point, the terminal 230 may use part of the common direct mode zone to transmit the information about the cell-specific direct mode zone. The terminal 230 may transmit the information about the cell-specific direct mode zone through a preset area (for example, a preamble shown in FIGS. 3 to 5). Herein, the information about the cell-specific direct mode zone may be the position and size of the cell-specific direct mode zone. As such, even though the terminal 240 is located outside the cell coverage A, the information about the cell-specific direct mode zone allocated from the base station 100 can be acquired by monitoring the already-known common direct mode zone (or preset area) alone.

Moreover, the terminal 230 and the terminal 240 perform direct communication by using the common direct mode zone and/or the cell-specific direct mode zone (S230).

Although only direct communication between the terminal 230 within the cell coverage A and the terminal 240 outside the cell coverage A has been described by way of example for better comprehension and ease of description, the present invention is not limited thereto. That is, the technical idea of the present invention can be applied to direct communication between the terminals 250 and 260 outside the cell coverage A, as well as to direct communication between the terminals 210 and 220 within the cell coverage A.

As such, the terminals outside the cell coverage as well as the terminals within the cell coverage already know the information about the common direct mode zone. Thus, direct communication between terminals is enabled even though a terminal receives no control information about resources for direct communication between terminals directly from a base station. Therefore, the amount of calculation required for acquiring initial synchronization or receiving control information can be reduced, and the power consumption of the terminal can also be reduced.

Moreover, by fluidly allocating the cell-specific direct mode zone per cell, the size of the common direct mode zone can be minimized, thus reducing resource waste in a base station in which direct communication between terminals is not used. Further, it is possible to increase resource efficiency by allocating the cell-specific direct mode zone to a base station having a high demand for direct communication between terminals or allocating it for direct communication between terminals outside a cell coverage.

In addition, a terminal does not need to receive a downlink control channel transmitted from a base station in order to acquire information about resources allocated for direct communication between terminals. Additionally, there is no need to change the format of control information transmission of a legacy system in order to transmit resource allocation information for direct communication between terminals.

Further, a terminal is able to alternately use the common direct mode zone and the cell-specific direct mode zone according to a channel situation. That is, in the case of direct communication between terminals, a terminal may use the common direct mode zone resources for the purpose of synchronization acquisition, link setup, and transmission of information about the cell-specific direct mode zone resources. If the terminal acquires the information about the cell-specific direct mode zone, the terminal may perform direct communication while changing between the common direct mode zone and the cell-specific direct mode zone. To this end, resource change information may be contained in resource allocation information or control information which is transmitted during link setup.

FIGS. 3 to 5 show a frame structure in which resources for direct communication between terminals are allocated according to an exemplary embodiment of the present invention.

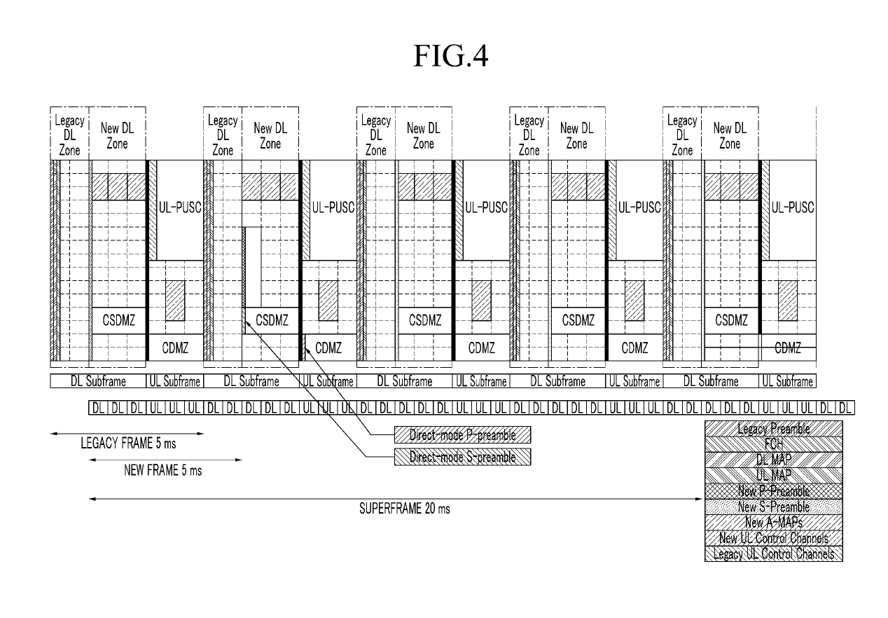

FIG. 3 and FIG. 4 illustrate an example in which resources for direct communication between terminals are allocated in a frequency division multiplex (FDM)-time division multiplex (TDM) manner. According to FIG. 3, the common direct mode zone and the cell-specific direct mode zone are allocated in different frequency domains for the same time domain (e.g., three DL subframes and three UL subframes). According to FIG. 4, the common direct mode zone and the cell-specific direct mode zone are allocated in different frequency domains for different time domains (e.g., the cell-specific direct mode zone are allocated to three DL subframes and the common direct mode zone are allocated to three UL subframes).

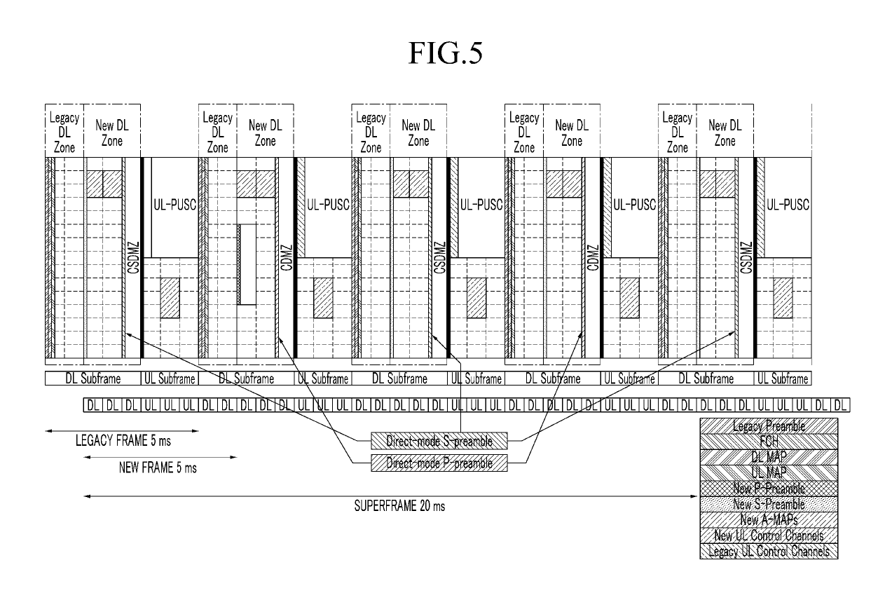

FIG. 5 illustrates an example in which resources for direct communication between terminals are allocated in a TDM manner. According to FIG. 5, the common direct mode zone or the cell-specific mode zone are allocated over the entire frequency domain for a specific time domain.

FIG. 3 to FIG. 5 are an example in which a new system (e.g., IEEE 802.16n) supporting a legacy system (IEEE 802.16m) allocates resources for direct communication between terminals. Further, the common direct mode zone and the cell-specific direct mode zone can be allocated in a variety of modified examples.

The above description is made by taking an example in which resources for direct communication between terminals are classified into the common direct mode zone and the cell-specific direct mode zone. Meanwhile, the resources for direct communication between terminals may be classified into the common direct mode resource, the cell-specific mode resource, and common direct mode resource extended (common direct mode zone extended, CDMZ-E). Hereinbelow, repeated description of the common direct mode resource and the cell-specific mode resources will be omitted.

The common direct mode zone extended are identical to the common direct mode zone in that is resources allocated for a predetermined size and position. However, whether to use the common direct mode zone extended or not is determined by each base station, and the common direct mode zone extended is different from the common direct mode zone in that information about the common direct mode zone extended is transmitted through the common direct mode zone. That is, a terminal performing direct communication does not need to receive control information individually from a base station because it uses the common direct mode zone. However, if the base station determines to further use the common direct mode zone extended for direct communication between terminals, information of the common direct mode zone extended can be transmitted to the terminal via a synchronization channel.

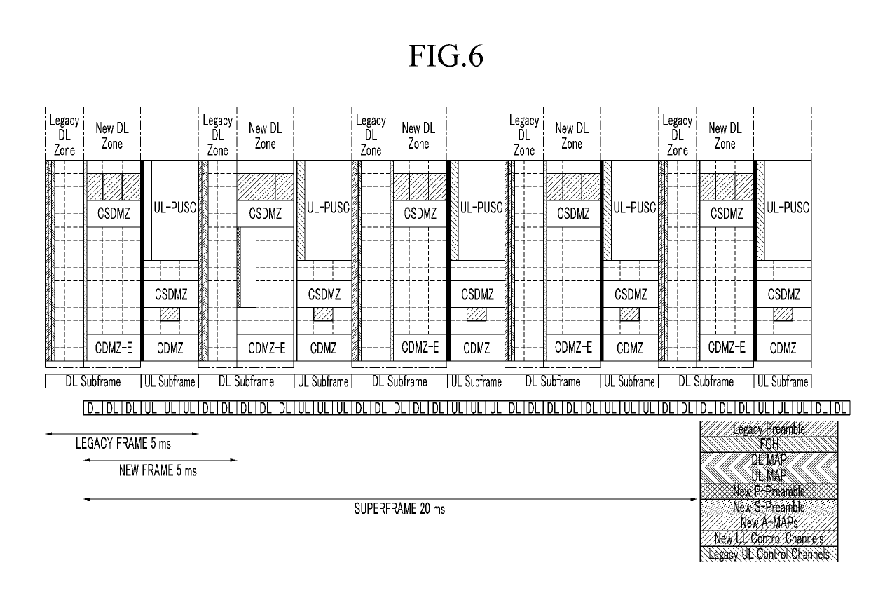

FIG. 6 shows a frame structure in which resources for direct communication between terminals are allocated according to another exemplary embodiment of the present invention.

Referring to FIG. 6, the common direct mode resource (common direct mode zone, CDMZ), the cell-specific direct mode resource (cell-specific direct mode zone, CSDMZ), and the common direct mode resource extended (common direct mode zone extended, CDMZ-E) are allocated as resources for direct communication between terminals. For example, the common direct mode zone is allocated to a predetermined frequency band of an uplink area of each frame, the cell-specific direct mode zone is allocated in a predetermined frequency band for part of an uplink or downlink area of each frame, and the common direct mode zone extended may be allocated in a predetermined frequency band for part of a downlink area of each frame.

Meanwhile, in a new system (e.g., IEEE 802.16n), a base station has to support a legacy terminal (e.g., IEEE 802.16m terminal) as well. Thus, it is necessary to allocate the common direct mode zone for the same position and size regardless of base station while supporting a normal operation of the legacy. Hereinafter, a concrete method for allocating the common direct mode zone for direct communication between terminals will be described.

PRUs (physical resource units), which are basic allocation units of physical resources in IEEE 802.16m, are divided into a plurality of frequency partitions (FPs) regardless of base station. Each FP is divided into subband PRUs allocated in units of four PRUs and miniband PRUs allocated in units of one PRU. The subband PRUs may be mapped to CRUs (contiguous resource units) allocated in units of contiguous subcarriers. The miniband PRUs may be mapped to CRUs, or mapped to DRUs (distributed resource units) which are remapped to a resource allocation block of subcarriers of PRUs for resource allocation.

At this point, a method for mapping DRUs from PRUs may differ from base station to base station. Therefore, in order to allocate the common direct mode zone for the same position and size regardless of base station, part of the subband PRUs mapped dedicatedly to CRUs may be used. At this point, there is a need to allocate the common direct mode zone excluding the resources for a commonly allocated E-MBS (enhanced multicast broadcast service) regardless of base station.

Specifically, the common direct mode zone can be continuously allocated to PRU regions as subband PRUs at various option values of DSAC or USAC representing the ratio of subband PRUs and miniband PRUs.

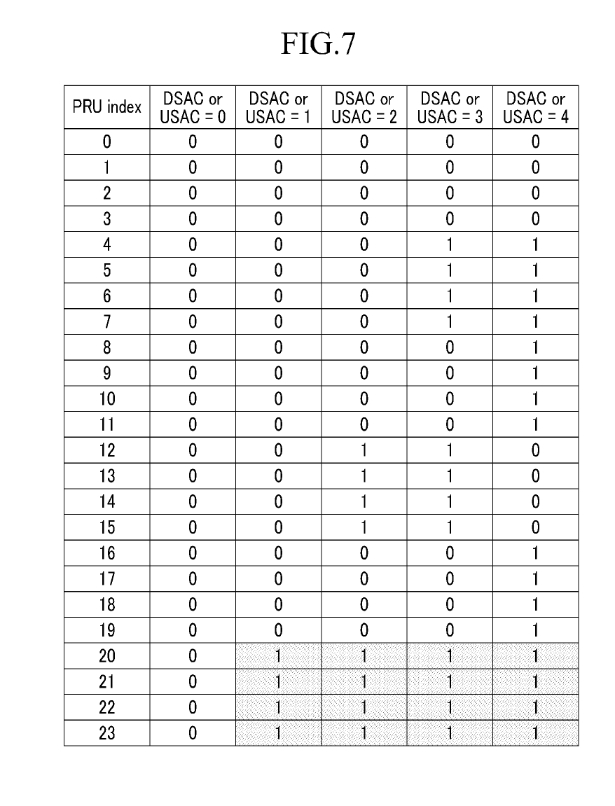

FIG. 7 to FIG. 9 are tables showing a method for allocating PRUs to common direct mode resource according to an exemplary embodiment of the present invention.

Referring to FIG. 7 in which a FFT (fast Fourier transform) size=512, PRU indices 20, 21, 22, and 23 may be continuously allocated as subband PRUs at option values except DSAC=0 or USAC=0.

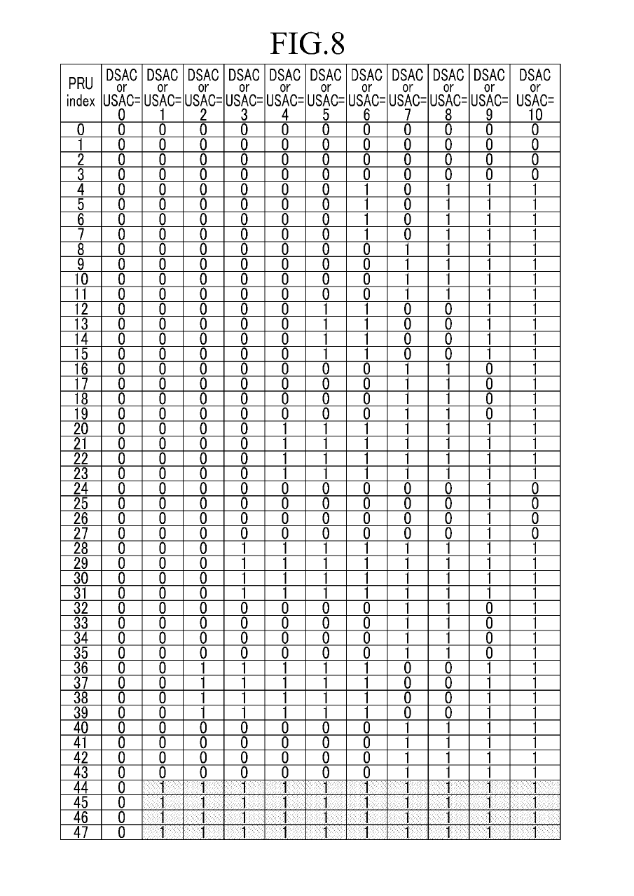

Referring to FIG. 8 in which FFT size=1024, PRU indices 44, 45, 46, and 47 may be continuously allocated as subband PRUs at option values except DSAC=0 or USAC=0.

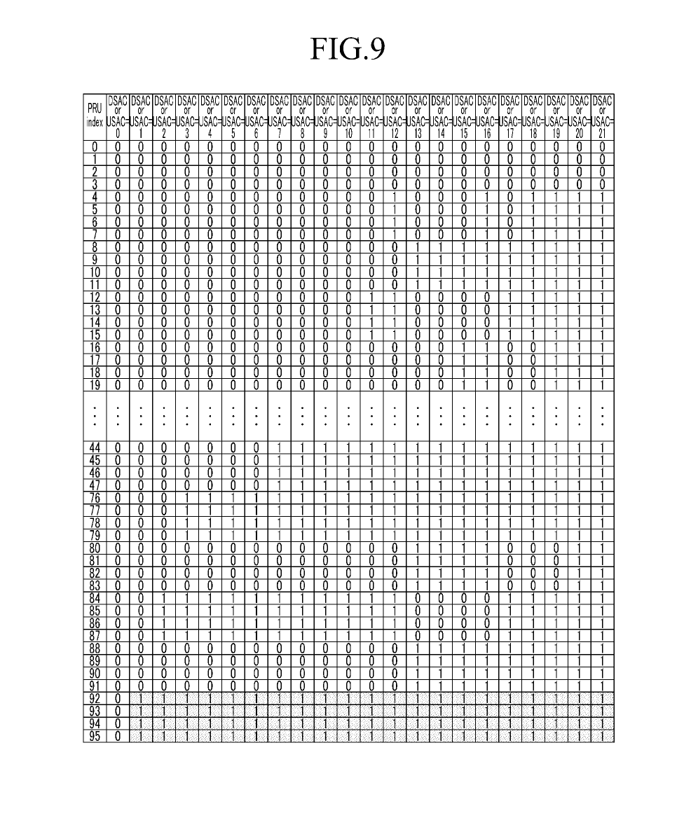

Referring to FIG. 9 in which FFT size=2048, PRU indices 92, 93, 94, and 95 may be continuously allocated as subband PRUs at option values except DSAC=0 or USAC=0.

In this way, the four highest contiguous PRUs may be allocated to the common direct mode resources.

If there is a need to allocate more PRU regions to the common direct mode zone resources, PRU regions (e.g., PRUs 28, 29, 30, and 31, which are all allocated as subband PRUs except when FFT size=1024 and DSAC or USAC=0, 1, or 2) continuously allocated as subband PRUs at the next more option value may be allocated to the common direct mode zone resources.

If the DSAC or USAC value of IEEE 802.16n system is an option value at which PRUs allocated to the common direct mode resources are allocated as miniband PRUs, the base station should allocate the PRUs as CRUs but should not allocate the PRUs for cellular communication.

Next, a frame structure according to a first exemplary embodiment of the present invention will be described. Herein, a frame includes direct mode zone resources for direct communication between terminals. Resources for direct communication between terminals may be common direct mode zone resources and/or cell-specific direct mode zone resources.

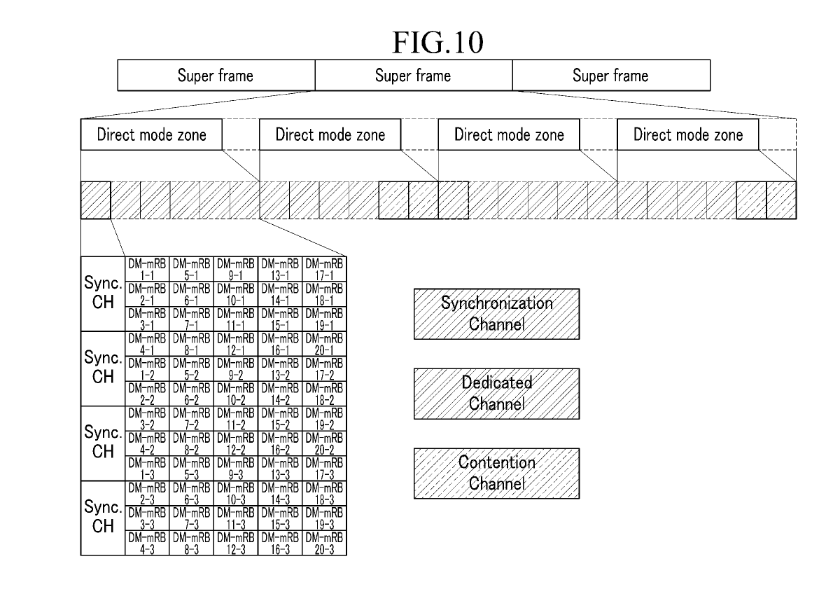

FIG. 10 is a view showing a frame structure according to a first exemplary embodiment of the present invention.

Referring to FIG. 10, a superframe includes a plurality of frames (e.g., four frames), and each frame includes resources for direct communication between terminals.

The resources for direct communication between terminals may be allocated to a plurality of subframes (e.g., six subframes). Resources for direct communication allocated to each frame may include at least one of a synchronization channel, a dedicated channel, and a contention channel.

For example, a synchronization channel and a dedicated channel may be allocated as resources for direct communication of the first frame in the superframe, and a dedicated channel and a contention channel may be allocated as resources for direction communication of the second frame. However, this is merely an illustration, and a variety of modifications can be made.

The synchronization channel may be composed of a synchronization message containing synchronization information for direct communication between terminals. For example, the synchronization channel may include at least one of a reference signal (e.g., preamble) required for acquiring frequency synchronization or time synchronization between terminals, hop count information about how many hops for relaying are used to be connected to a base station, base station information, information about a terminal transmitting the synchronization channel, information about a terminal receiving the synchronization channel, and information about a frame structure (e.g., arrangement of the dedicated channel and the contention channel).

The dedicated channel is a channel for sending and receiving direct communication data between terminals.

The contention channel is a channel for acquiring the right of use of the dedicated channel. The contention channel may reserve the dedicated channel through CSMA-CA (carrier sense multiple access with collision avoidance), and transmit a synchronization channel reception acknowledgement message. A pair of terminals for direct communication spatially apart from each other may communicate by using the same contention channel through CSMA-CA.

Resources for direct communication between terminals may be allocated over four contiguous PRU regions. The synchronization channel may be allocated over the entire frequency domain as the resources for direct communication.

According to the first exemplary embodiment of the present invention, a basic unit of resources for direct communication between terminals may include a plurality of resource blocks (RBs). For instance, PRUs may be divided into a plurality of mini-resource blocks (mRBs), and the plurality of mRBs may be combined into a basic unit of resources for direct communication between terminals. As such, a frequency diversity gain can be obtained, and, if desired, the number of subcarriers to be transmitted at a specific point of time can be limited, thus obtaining wider coverage.

The following description will be given on an example in which a basic unit of resources for direct communication between terminals is composed of a plurality of resource blocks according to the first exemplary embodiment of the present invention.

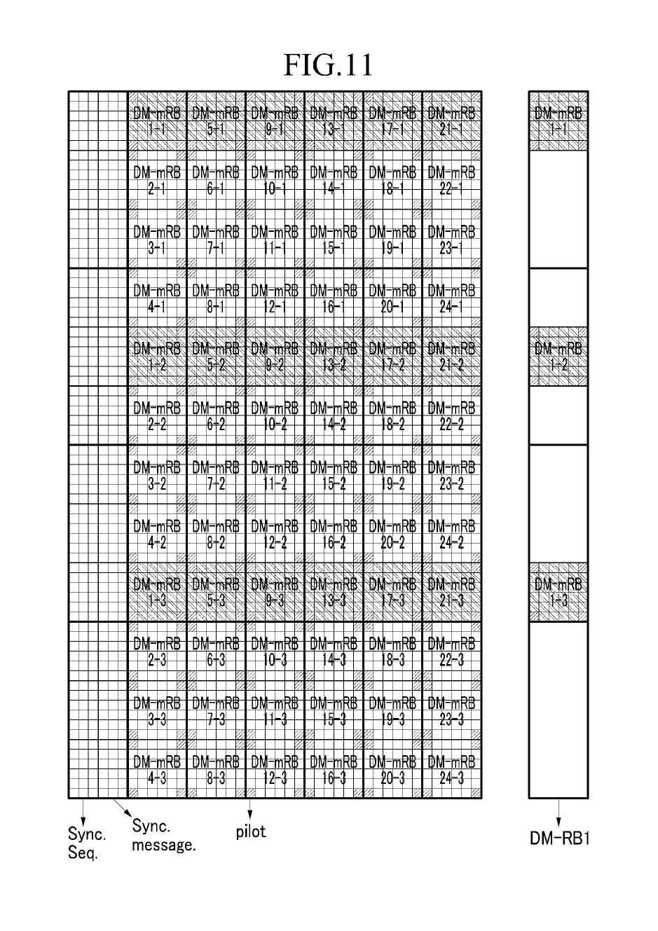

FIG. 11 to FIG. 14 are views showing a resource dividing method according to the first exemplary embodiment of the present invention.

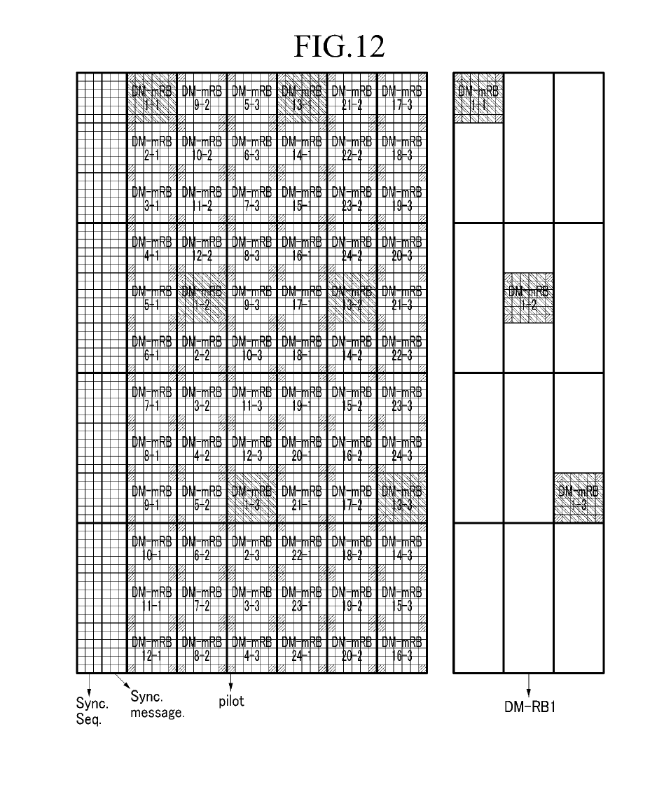

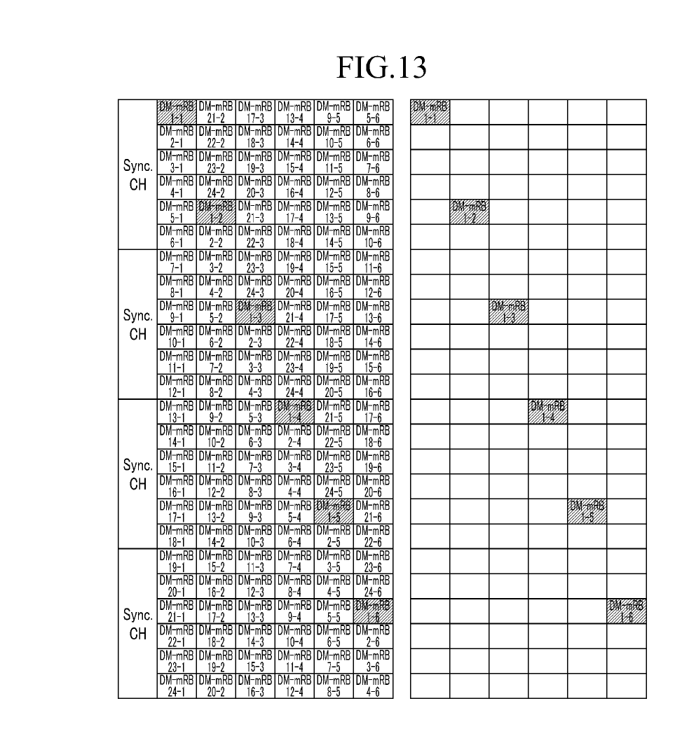

FIG. 11 to FIG. 13 show an example in which four contiguous PRU regions are allocated as resources for direct communication between terminals in an FDM manner. Referring to FIG. 11 and FIG. 12, one PRU may be divided into three mRBs. That is, one mRB may be composed of 6 subcarriers by 6 OFDM symbols. A basic unit (a direct mode resource block (DM-RB)) of resources for direct communication may be composed of three mRBs. The basic unit of resources for direct communication may be composed of mRBs (e.g., DM-mRB 1-1, DM-mRB 1-2, and DM-mRB 1-3 of FIG. 11) distributed in a subframe, or composed of mRBs (e.g., DM-mRB 1-1, DM-mRB 1-2, and DM-mRB 1-3 of FIG. 12) distributed in different subframes. Referring to FIG. 13, one PRU may be divided into 6 mRBs. That is, one mRB may be composed of 3 subcarriers by 6 OFDM symbols. A basic unit of resources for direct communication may be composed of 6 mRBs. The basic unit of resources for direct communication may be composed of mRBs distributed in a subframe, or composed of mRBs (e.g., DM-mRB 1-1, DM-mRB 1-2, DM-mRB 1-3, DM-mRB 1-4, DM-mRB 1-5, and DM-mRB 1-6 of FIG. 13) distributed in different subframes.

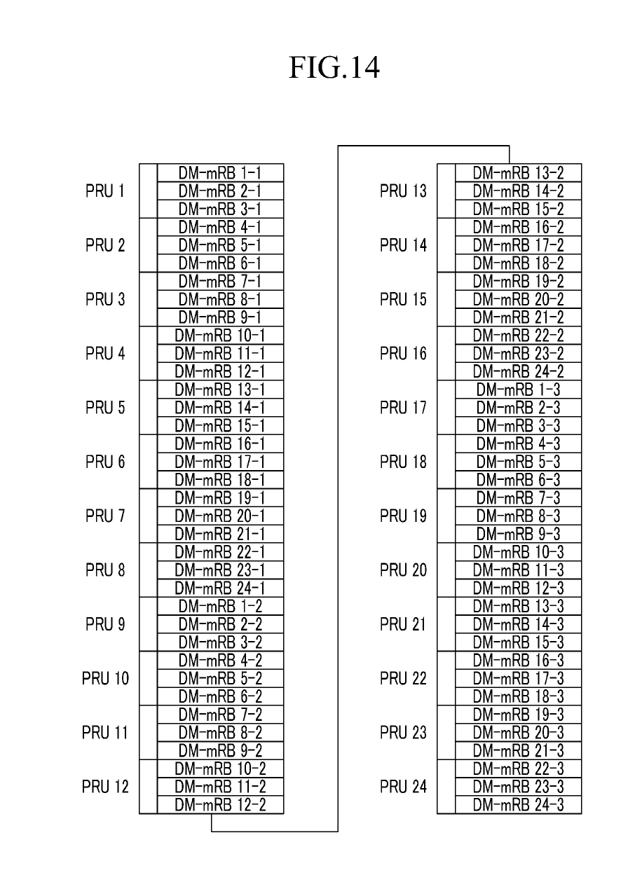

FIG. 14 shows an example in which all PRU regions are allocated as resources for direct communication between terminals. That is, FIG. 14 shows an example in which resources for direct communication between terminals are allocated to one subframe in a TDM manner. Herein, one PRU may be divided into three mRBs. As the first OFDM symbol of the subframe allocated as the resources for direct communication between terminals is allocated to the synchronization channel, one mRB may be composed of 6 subcarriers by 5 OFDM symbols. A basic unit of resources for direct communication may be composed of three mRBs. Herein, a basic unit of resources for direct communication also may be composed of a plurality of mRBs distributed in a frequency domain. Therefore, a frequency diversity gain can be obtained.

Next, a frame structure according to a second exemplary embodiment of the present invention will be described. Here, a frame includes resources for direct communication between terminals (direct mode zone resources). The direct mode zone resources may be at least one of common direct mode zone resources, cell-specific direct mode zone resources, and common direct mode zone extended resources.

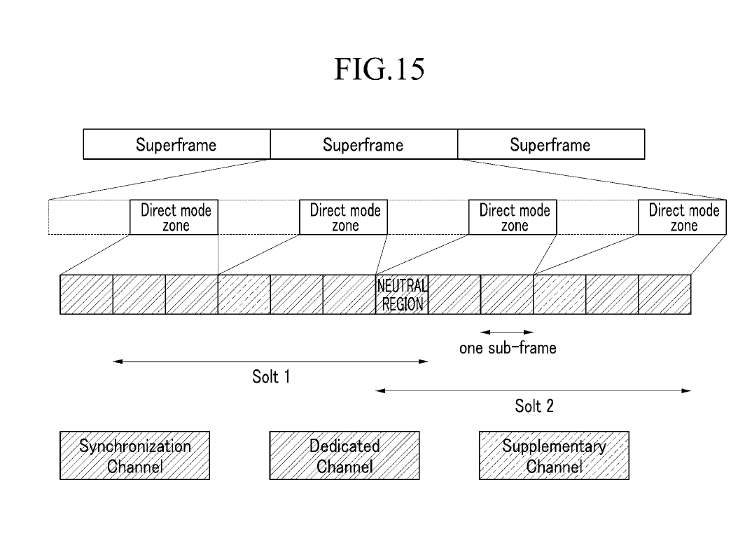

FIG. 15 is a view showing a frame structure according to the second exemplary embodiment of the present invention.

Referring to FIG. 15, a superframe includes a plurality of frames (e.g., four frames), and each frame includes resources for direct communication between terminals.

The resources for direct communication between terminals may be allocated to a plurality of subframes (e.g., three subframes). The resources for direct communication allocated to each frame may include at least one of a synchronization channel, a dedicated channel, and a supplementary channel.

The synchronization channel may include synchronization information for direct communication between terminals. For example, the synchronization channel may include a synchronization message containing at least one of a reference signal (e.g., synchronization preamble) required for acquiring frequency synchronization or time synchronization between terminals, hop count information about how many hops for relaying are used to be connected to a base station, base station information, information about a terminal transmitting the synchronization channel, information about a terminal receiving the synchronization channel, and information about a frame structure (e.g., arrangement of the dedicated channel and the contention channel). The synchronization preamble and the synchronization message may be transmitted in a TDM manner. Information about the cell-specific direct mode zone resources and the common direct mode zone extended resources may be transmitted through the synchronization channel.

The dedicated channel is a channel for sending and receiving a direct communication packet between terminals. The direct communication packet may contain data and control information. The dedicated channel may include a plurality of dedicated subchannels, each allocated for physical resources of a predetermined size. The dedicated channel in the superframe is divided into two or more slots, and each of the dedicated subchannels contains only the resources corresponding to each slot. If necessary, data is not transmitted, but instead a physical layer signaling signal of a specific numerical sequence may be mapped to resource blocks constituting a dedicated subchannel and transmitted. At this point, the physical layer signaling signal may be piggybacked on a data packet in the transmission. For link adaptation of the dedicated channel, data can be transmitted at a transmission rate that is suitable for the channel state by a combination of a method for varying combinations of a modulation scheme (e.g., QPSK, 16QAM, and 64QAM) and the code rate of the channel code, and a method for regulating transmission power.

A supplementary channel is an additional channel corresponding one-to-one to each dedicated subchannel constituting the dedicated channel. The supplementary channel uses CSMA-CA in order to acquire the right of use of each dedicated subchannel. The supplementary channel aims at transmitting and receiving RTS and CTS to reserve a dedicated channel, transmitting an indicator indicating the transmission of a specific MAC message in a corresponding dedicated channel, transmitting ACK/NACK indicating the success or failure of packet decoding in a packet transmission process, transmitting CQI, CSI, and RI (rank information) required for link adaptation, transmitting a synchronization channel reception acknowledgment message required for maintaining and acquiring the synchronization of MCS transmission, a ranging response, and a ranging signal, transmitting a MAC management message of a short length, and transmitting a physical layer signaling signal. The supplementary channel may be located in a different slot from that of the one-to-one corresponding dedicated subchannel so as to enable the reception of feedback information about the dedicated subchannel. For link adaptation of the supplementary channel, transmission power may be regulated by using a fixed modulation scheme and a code rate. If one packet is transmitted through a plurality of dedicated subchannels, it may be repeatedly encoded into the supplementary channel corresponding to the plurality of dedicated subchannels.

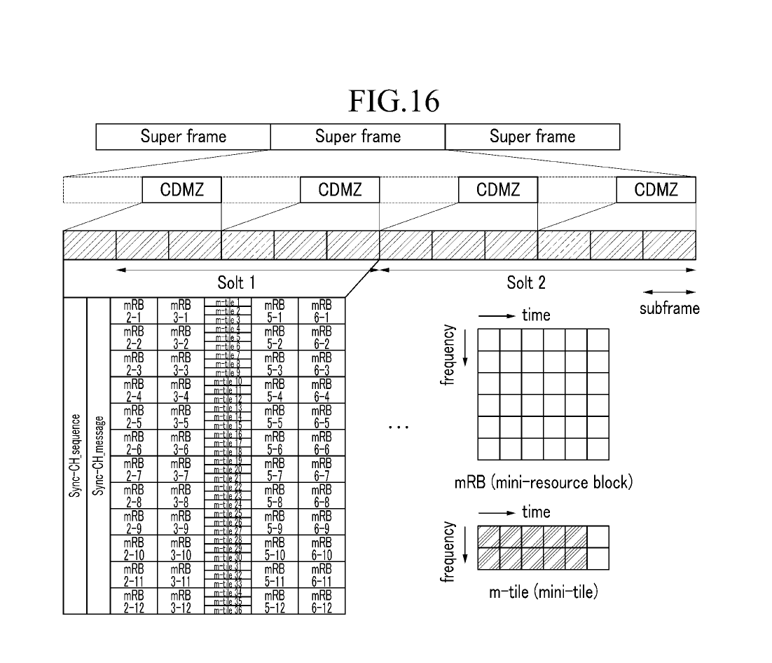

FIG. 16 is a view concretely showing a frame structure including common direct mode zone resources among resources for direct communication between terminals according to the second exemplary embodiment of the present invention.

Referring to FIG. 16, a superframe includes a plurality of frames (e.g., four frames), and each frame includes common direct mode zone resources. The common direct mode zone resources may be allocated to a plurality of subframes (e.g., three subframes). It is illustrated that the common direct mode zone resources are allocated to four contiguous PRUs for each frame in an FDM manner.

A synchronization channel is transmitted over the entire frequency (e.g., 4 PRUs) domain of the common direct mode zone resources. Each PRU may be divided into mini-resource blocks (mRBs) for a dedicated channel and a supplementary channel, and a plurality of mRBs may constitute a dedicated subchannel or a supplementary channel. It is illustrated that one PRU is divided into three mRBs.

Meanwhile, if several types of resources (common direct mode zone resources, cell-specific direct mode zone resources, and common direct mode zone extended resources) are allocated as shown in FIG. 16, a separate frame is configured for each resource type, and a separate frame is configured for a predetermined unit (e.g., 4 PRUs) within the same zone resources. However, the synchronization channel is transmitted only through the common direct mode zone resources, and the first subframe in the remaining area is allocated for dedicated channel resources.

Now, description will be given on an example in which a basic unit of resources for direct communication between terminals is composed of a plurality of resource blocks (RBs).

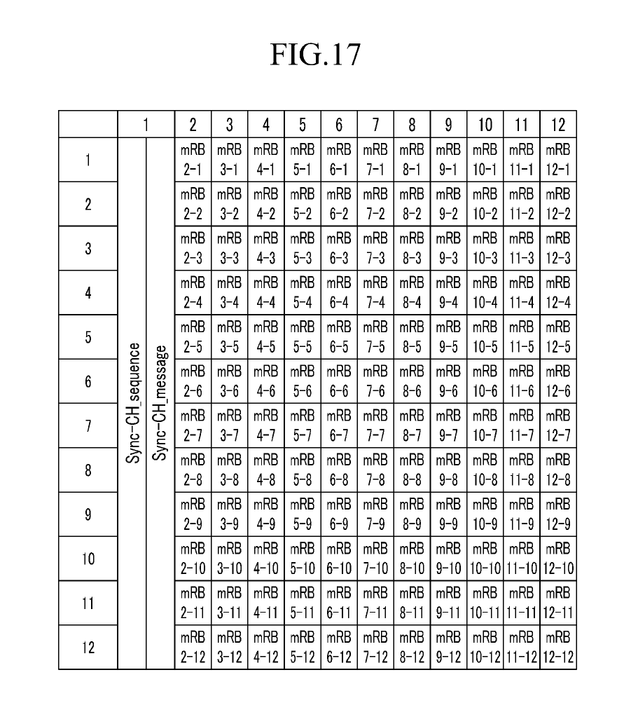

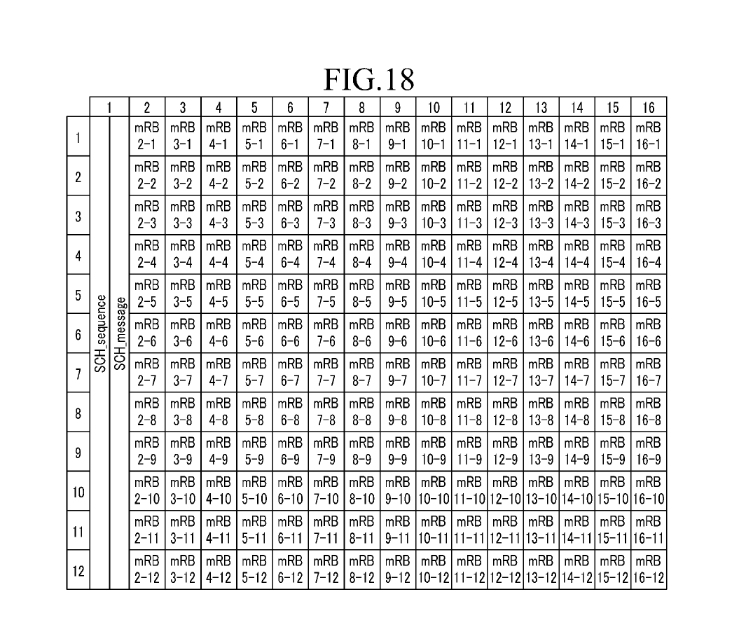

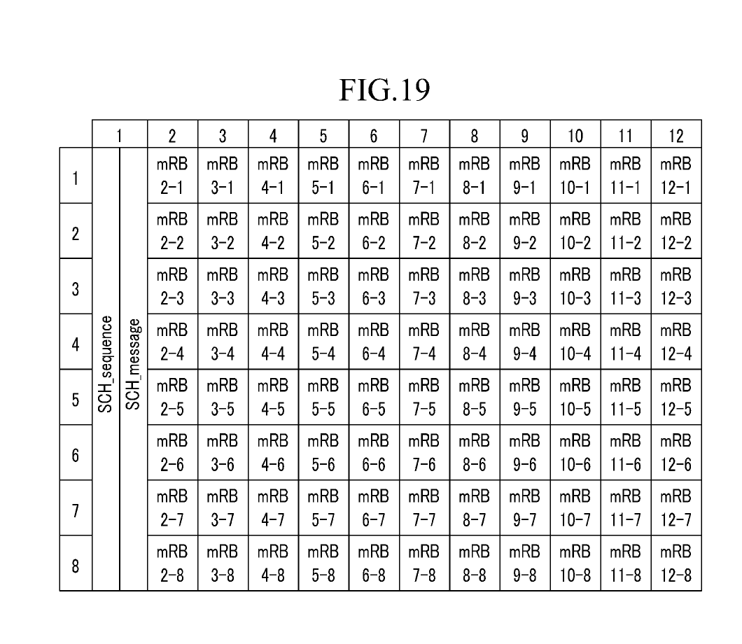

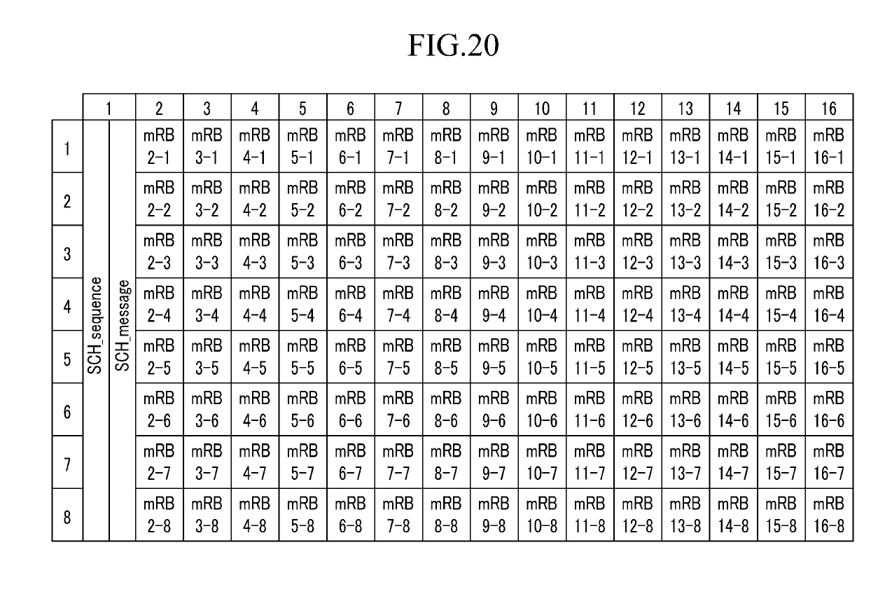

FIG. 17 to FIG. 20 are views showing a resource dividing method according to the second exemplary embodiment of the present invention. FIG. 17 to FIG. 20 show an example in which four contiguous PRU regions are allocated as resources for direct communication between terminals. According to FIG. 17 and FIG. 18, one mRB may be divided into three mRBs. That is, one mRB may be composed of 6 subcarriers by 6 OFDM symbols. FIG. 17 is an example in which three subframes are allocated for every frame (e.g., at intervals of 5 ms) as resources for direct communication between terminals, and FIG. 18 is an example in which 4 subframes are allocated for every frame as resources for direct communication between terminals. According to FIG. 19 and FIG. 20, two PRUs may be divided into three mRBs. That is, one mRB may be composed of 9 subcarriers by 6 OFDM symbols. FIG. 19 is an example in which three subframes are allocated for every frame as resources for direct communication between terminals, and FIG. 20 is an example in which four subframes are allocated for every frame as resources for direct communication between terminals.

In FIG. 17 to FIG. 20, the numbers on the horizontal axis indicate the indices of subframes, and the numbers on the vertical axis indicate the indices of mRBs. For example, mRB a-b represents the b-th mRB of the a-th subframe. Herein, only the subframes including the resources for direct communication between terminals are illustrated, and the other subframes are omitted.

Next, a method for mapping a basic unit mRB of resources for direct communication between terminals into a dedicated channel and a supplementary channel will be described.

To this end, it is assumed that a superframe is divided into two slot regions. That is, in the case that n subframes are allocated for every frame for direct communication between terminals, a total of 4n subframes are allocated as resources for direct communication between terminals in the superframe. The subframes allocated as the resources for direct communication between terminals within one superframe may be sequentially numbered 1, 2, . . . , 4n. Among the 4n−1 subframes excluding the first subframe, 2 to 2n subframes may be allocated as slot 1, and 2n+1 to 4n subframes may be allocated as slot 2.

In each slot, one or more subframes are allocated for a supplementary channel, and the other subframes may be allocated for a dedicated channel.

In each slot, part of mRBs located in the subframes allocated to the dedicated channel may be collected and constitute a dedicated subchannel. The dedicated subchannel may be composed of a predetermined number (N_mRB_dedicated) of mRBs distributed over the entire frequency band allocated as resources for direct communication between terminals.

A one-to-one corresponding supplementary subchannel exists in each dedicated subchannel. A supplementary subchannel corresponding to the dedicated subchannel belonging to slot 1 may be located in slot 2. A supplementary subchannel corresponding to the dedicated subchannel belonging to slot 2 may be located in slot 2. By this, a receiving terminal is able to transmit Ack/Nack indicating whether the decoding of data transmitted through the dedicated subchannel belonging to slot 1 is successful or not through the supplementary subchannel belonging to slot 2. Accordingly, if the receiving terminal fails to decode data, a transmitting terminal may re-transmit the data in the next superframe, thereby reducing re-transmission delay.

The subframe allocated to the supplementary subchannel may be set as the first subframe of the second frame constituting each slot. Accordingly, the processing time required for decoding data transmitted through the dedicated channel and the processing time required for decoding information transmitted through the supplementary channel can be ensured.

A basic unit for the supplementary subchannel may be a unit that is smaller than mRB which is a basic unit of resources for direct communication between terminals. To this end, mini-tiles divided from mRB may be set as a basic unit for the supplementary subchannel. For example, one mRB may be divided into two or three mini-tiles. A predetermined number of mini-tiles distributed over the entire frequency band may constitute the supplementary subchannel. Accordingly, a frequency diversity gain can be obtained.

To ensure a guard time required for a terminal to switch between transmission mode and reception mode, no signal may be transmitted in the last OFDM symbol of the subframe allocated to the supplementary subchannel.

Meanwhile, a neutral region may exist near the boundary between slot 1 and slot 2. The neutral region may be allocated additional resources for the dedicated subchannel allocated to slot 1 and the dedicated subchannel allocated to slot 2. Even if two-way communication is required between the dedicated subchannel allocated to slot 1 and the dedicated subchannel allocated to slot 2, both of the dedicated subchannels cannot be allocated together to the neutral region.

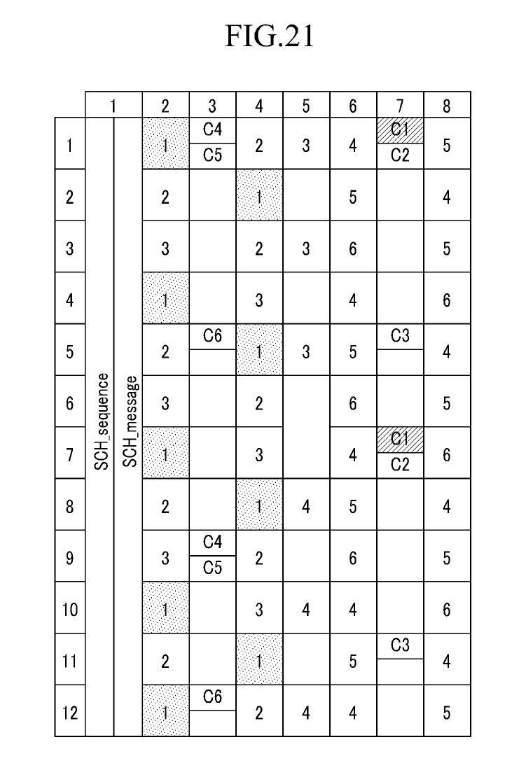

FIG. 21 is a view showing a method for mapping a dedicated channel and a supplementary channel according to an exemplary embodiment of the present invention.

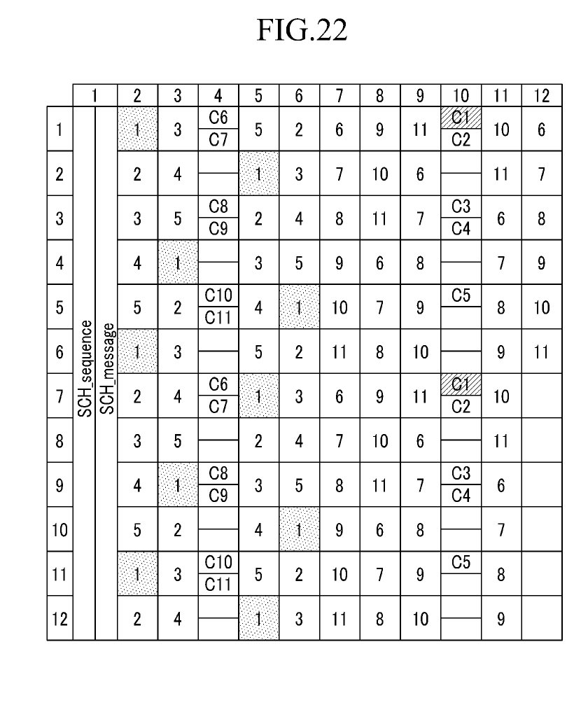

Referring to FIG. 22, two subframes are allocated for every frame for direct communication between terminals. Therefore, the first subframe is allocated to a synchronization channel, the second to fourth subframes are allocated to slot 1, and the fifth to eighth subframes are allocated to slot 2.

The third subframe of slot 1 and the seventh subframe of slot 2 (i.e., the first subframe of the second frame of each slot) are allocated for supplementary subchannels, and the other subframes are allocated for dedicated subchannels.

Each dedicated subchannel may be composed of 9 mRBs (6 subcarriers by 6 OFDM symbols) corresponding to three PRUs, and each supplementary subchannel may be composed of two mini-tiles (3 subcarriers by 5 OFDM symbols). Nine mRBs constituting each dedicated subchannel are uniformly distributed over the subframes in the slots within the frequency band, and two mini-tiles constituting each supplementary subchannel are distributed within the frequency band. The numbers (e.g., 1 to 6) written on the mRBs allocated to the dedicated channel indicate the indices of dedicated subchannels, and the numbers (e.g., C1 to C6) written on the mini-tiles allocated to the supplementary channel indicate the indices of supplementary subchannels.

A supplementary subchannel (e.g., C1) corresponding to the dedicated subchannel (e.g., first dedicated subchannel) allocated to slot 1 is allocated to slot 2.

Meanwhile, if the fifth subframe is set as a neutral region, dedicated subchannels requiring two-way communication cannot be allocated together to the fifth subframe. For instance, if two-way communication is required between the third dedicated subchannel allocated to slot 1 and the sixth dedicated subchannel allocated to slot 2, the third dedicated subchannel and the sixth dedicated subchannel cannot be simultaneously allocated to the fifth subframe. If the third dedicated subchannel is allocated to the fifth subframe, the fourth or fifth dedicated subchannel, other than the sixth dedicated channel, may be allocated.

FIG. 22 is a view showing a method for mapping a dedicated channel and a supplementary channel according to another exemplary embodiment of the present invention.

Referring to FIG. 22, three subframes are allocated for every frame for direct communication between terminals. Accordingly, the first subframe is allocated to the synchronization channel, the second to sixth subframes are allocated to slot 1, and the seventh to twelfth subframes are allocated to slot 2.

The fourth subframe of slot 1 and the tenth subframe of slot 2 (i.e., the first subframe of the second frame of each slot) are allocated for supplementary subchannels, and the other subframes are allocated for dedicated subchannels.

Each dedicated subchannel may be composed of 9 mRBs (6 subcarriers by 6 OFDM symbols) corresponding to three PRUs, and each supplementary subchannel may be composed of two mini-tiles (3 subcarriers by 5 OFDM symbols). Nine mRBs constituting each dedicated subchannel are uniformly distributed over the subframes in the slots within the frequency band, and two mini-tiles constituting each supplementary subchannel are distributed within the frequency band. The numbers (e.g., 1 to 11) written on the mRBs allocated to the dedicated channel indicate the indices of the dedicated subchannels, and the numbers (e.g., C1 to C11) written on the mini-tiles allocated to the supplementary channel indicate the indices of the supplementary subchannels. The supplementary subchannel (e.g., C1) corresponding to a dedicated subchannel (e.g., first dedicated subchannel) allocated to slot 1 is allocated to slot 2.

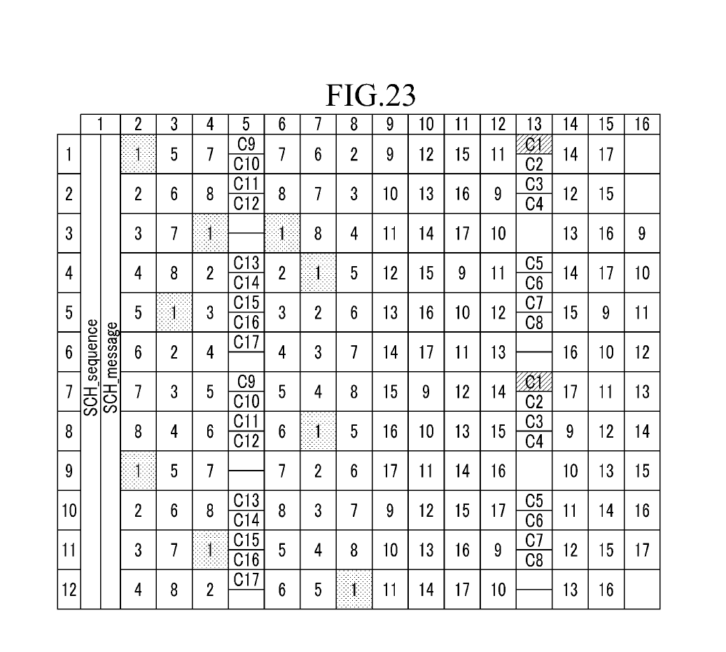

FIG. 23 is a view showing a method for mapping a dedicated channel and a supplementary channel according to yet another exemplary embodiment of the present invention.

Referring to FIG. 23, four subframes are allocated for every frame for direct communication between terminals. Accordingly, the first subframe is allocated to the synchronization channel, the second to eighth subframes are allocated to slot 1, and the ninth to sixteenth subframes are allocated to slot 2. The fifth subframe of slot 1 and the thirteenth subframe of slot 2 (i.e., the first subframe of the second frame of each slot) are allocated for supplementary subchannels, and the other subframes are allocated for dedicated subchannels.

Each dedicated subchannel may be composed of 9 mRBs (6 subcarriers by 6 OFDM symbols) corresponding to three PRUs, and each supplementary subchannel may be composed of two mini-tiles (3 subcarriers by 5 OFDM symbols). Nine mRBs constituting each dedicated subchannel are uniformly distributed over the subframes in the slots within the frequency band, and two mini-tiles constituting each supplementary subchannel are distributed within the frequency band. The numbers (e.g., 1 to 17) written on the mRBs allocated to the dedicated channel indicate the indices of the dedicated subchannels, and the numbers (e.g., C1 to C17) written on the mini-tiles allocated to the supplementary channel indicate the indices of the supplementary subchannels.

The supplementary subchannel (e.g., C1) corresponding to a dedicated subchannel (e.g., first dedicated subchannel) allocated to slot 1 is allocated to slot 2.

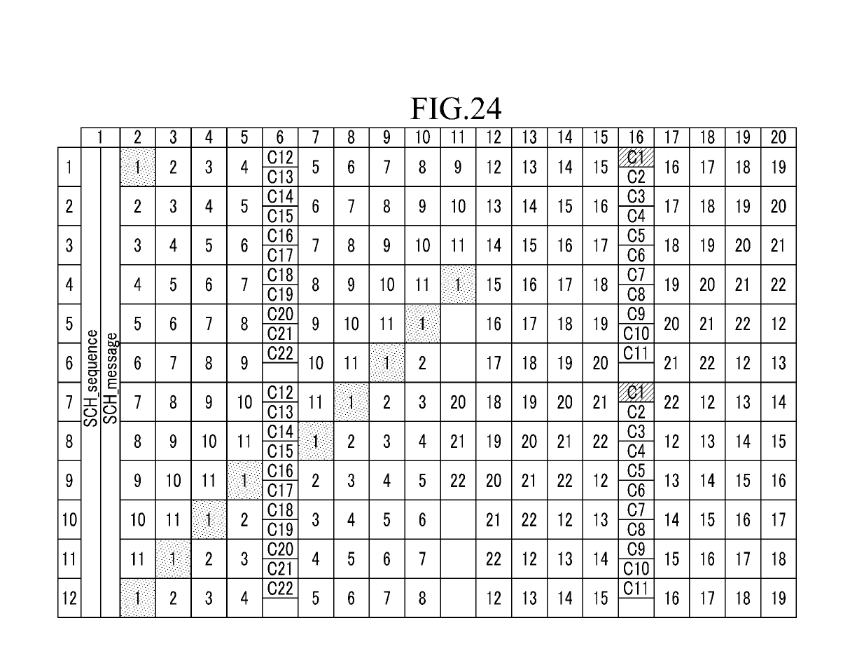

FIG. 24 is a view showing a method for mapping a dedicated channel and a supplementary channel according to still another exemplary embodiment of the present invention.

Referring to FIG. 24, 5 subframes are allocated for every frame for direct communication between terminals. Accordingly, the first subframe is allocated to the synchronization channel, the second to tenth subframes are allocated to slot 1, and the eleventh to twentieth subframes are allocated to slot 2.

The sixth subframe of slot 1 and the sixteenth subframe of slot 2 (i.e., the first subframe of the second frame of each slot) are allocated for supplementary subchannels, and the other subframes are allocated for dedicated subchannels.

Each dedicated subchannel may be composed of 9 mRBs (6 subcarriers by 6 OFDM symbols) corresponding to three PRUs, and each supplementary subchannel may be composed of two mini-tiles (3 subcarriers by 5 OFDM symbols). Nine mRBs constituting each dedicated subchannel are uniformly distributed over the subframes in the slots within the frequency band, and two mini-tiles constituting each supplementary subchannel are distributed within the frequency band. The numbers (e.g., 1 to 22) written on the mRBs allocated to the dedicated channel indicate the indices of the dedicated subchannels, and the numbers (e.g., C1 to C22) written on the mini-tiles allocated to the supplementary channel indicate the indices of the supplementary subchannels.

The supplementary subchannel (e.g., C1) corresponding to a dedicated subchannel (e.g., first dedicated subchannel) allocated to slot 1 is allocated to slot 2.

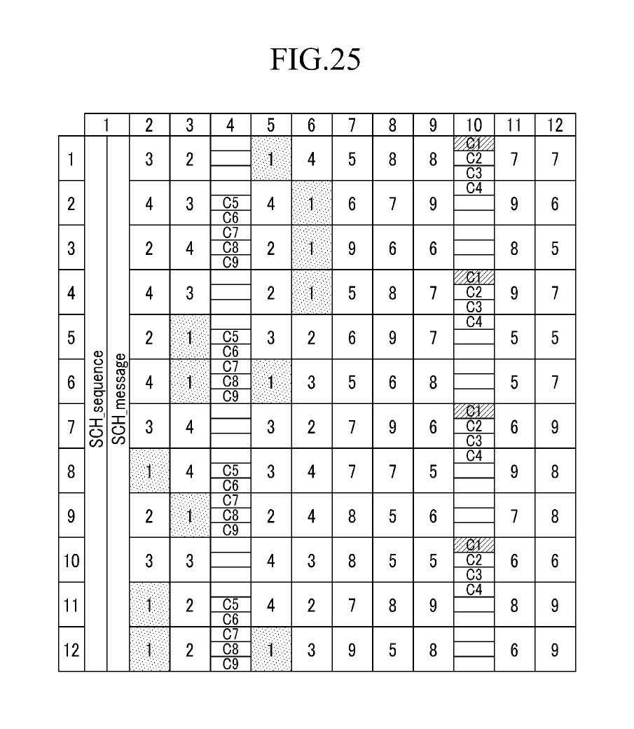

FIG. 25 is a view showing a method for mapping a dedicated channel and a supplementary channel according to a further exemplary embodiment of the present invention.

Referring to FIG. 25, three subframes are allocated for every frame for direct communication between terminals. Accordingly, the first subframe is allocated to the synchronization channel, the second to sixth subframes are allocated to slot 1, and the seventh to twelfth subframes are allocated to slot 2.

The fourth subframe of slot 1 and the tenth subframe of slot 2 (i.e., the first subframe of the second frame of each slot) are allocated for supplementary subchannels, and the other subframes are allocated for dedicated subchannels.

Each dedicated subchannel may be composed of 12 mRBs (6 subcarriers by OFDM symbols) corresponding to 4 PRUs, and each supplementary subchannel may be composed of 4 mini-tiles (2 subcarriers by 5 OFDM symbols). 12 mRBs constituting each dedicated subchannel are uniformly distributed over the subframes in the slots within the frequency band, and 4 mini-tiles constituting each supplementary subchannel are distributed within the frequency band. The numbers (e.g., 1 to 9) written on the mRBs allocated to the dedicated channel indicate the indices of the dedicated subchannels, and the numbers (e.g., C1 to C9) written on the mini-tiles allocated to the supplementary channel indicate the indices of the supplementary subchannels.

The supplementary subchannel (e.g., C1) corresponding to a dedicated subchannel (e.g., first dedicated subchannel) allocated to slot 1 is allocated to slot 2.

Hereinafter, in order to obtain a frequency diversity gain, a method for uniformly distributing a plurality of mRBs constituting each dedicated subchannel in a frequency domain and mapping them will be described.

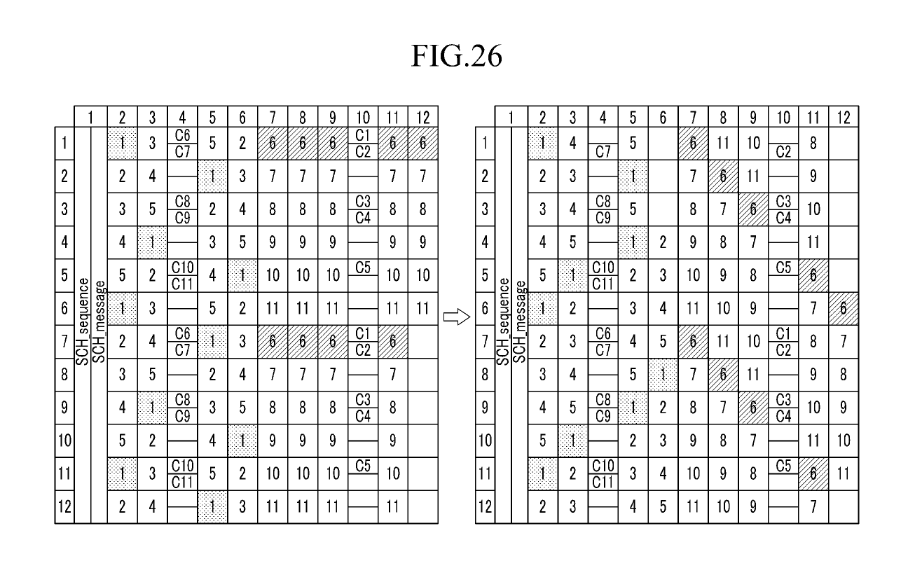

FIG. 26 shows a method for mapping a plurality of mRBs constituting each dedicated subchannel according to an exemplary embodiment of the present invention. Herein, the second to sixth subframes may be allocated to slot 1, and the seventh to twelfth subframes may be allocated to slot 2.

Referring to FIG. 26, first, 1−n_{Ded-sub-chj} are sequentially allocated to each mRB. Herein, n_{Ded-sub-chj} is (number of mRBs included in slot j/number of mRBs included in each dedicated subchannel). n_{Ded-sub-chj} is also the number of dedicated subchannels allocated to slot j. Therefore, if a total of five dedicated subchannels are allocated to slot j, and dedicated subchannel indices 1 to 5 are repeatedly allocated to each mRB, beginning from the lowest frequency domain of the lowest subframe index.

Next, a predetermined number of cyclic shifts are performed on each subframe. For example, each subframe may be modulo-operated by the subframe index, and cyclically shifted by the resulting value. FIG. 26(b) illustrates an example in which each subframe is cyclically shifted by the resulting value of a mod((subframe index per slot−1), 12) operation.

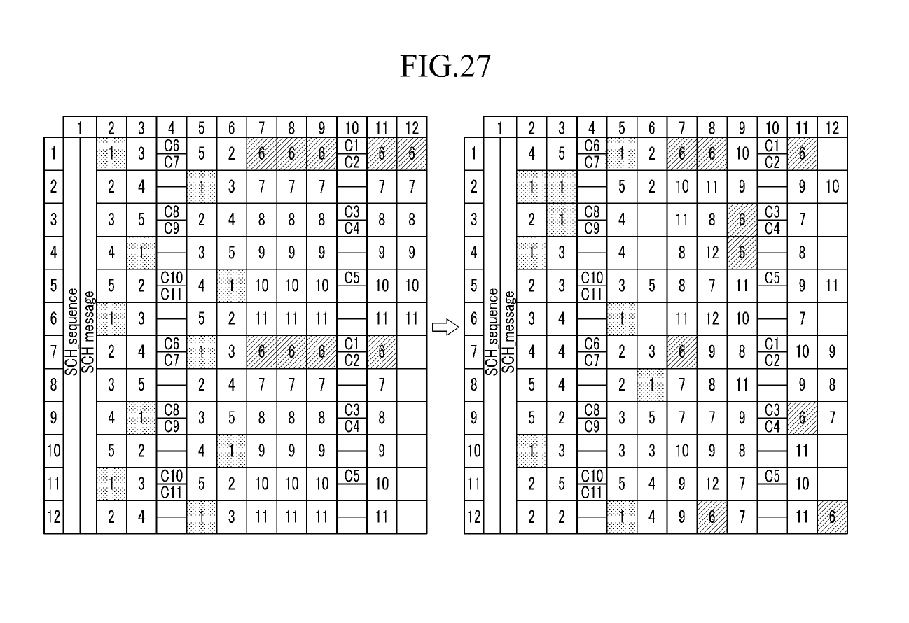

FIG. 27 shows a method for mapping a plurality of mRBs constituting each dedicated subchannel according to another exemplary embodiment of the present invention. Here, the second to sixth subframes may be allocated to slot 1, and the seventh to twelfth subframes may be allocated to slot 2.

Referring to FIG. 27, first, 1−n_{Ded-sub-chj} are sequentially allocated to each mRB. Herein, n_{Ded-sub-chj} is (number of mRBs included in slot j/number of mRBs included in each dedicated subchannel). n_{Ded-sub-chj} is also the number of dedicated subchannels allocated to slot j. Therefore, if a total of five dedicated subchannels are allocated to slot j, dedicated subchannel indices 1 to 5 are repeatedly allocated to each mRB, beginning from a low frequency domain of a low subframe index.

Next, permutation is performed on each subframe according to a predetermined permutation sequence. The predetermined permutation sequence may be a random sequence of IEEE 802.16m, for example. At this point, a seed value for generating a random sequence may be determined according to a subframe index.

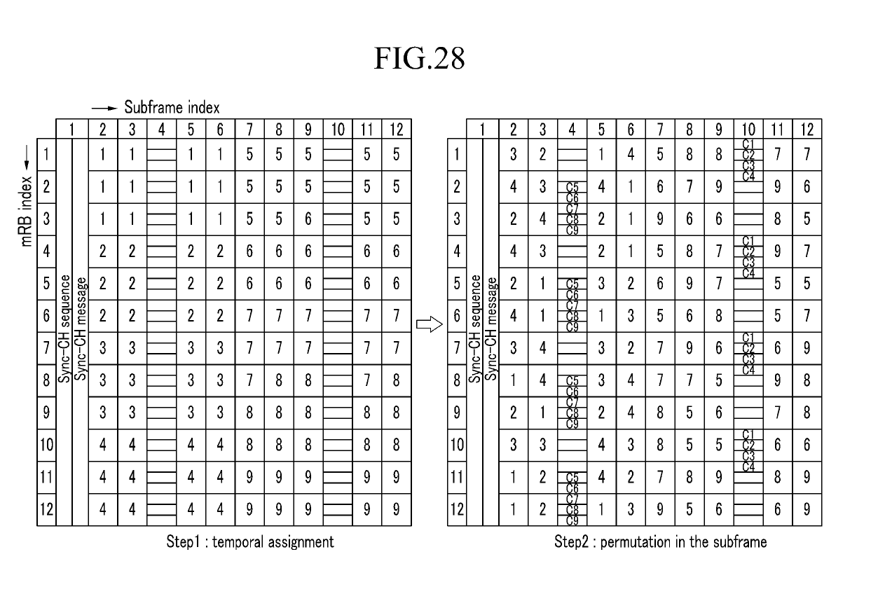

FIG. 28 shows a method for mapping a plurality of mRBs constituting each dedicated subchannel according to yet another exemplary embodiment of the present invention. Here, the second to sixth subframes may be allocated to slot 1, and the seventh to twelfth subframes may be allocated to slot 2.

Referring to FIG. 28, first, dedicated subchannel indices 1−n_{Ded-sub-chj} are sequentially allocated to each mRB. Herein, n_{Ded-sub-chj} is (number of mRBs included in slot j/number of mRBs included in each dedicated subchannel). n_{Ded-sub-chj} is also the number of dedicated subchannels allocated to slot j.

Dedicated subchannel index 1 may be allocated to all of 12 mRBs in a low frequency domain (mRB indices 1, 2, and 3 of subframe indices 2, 3, 5, and 6), and then dedicated subchannel indices 2, 3, 4, and 5 may be allocated in the same manner.

Next, permutation is performed on each subframe according to a predetermined permutation sequence. The predetermined permutation sequence may be a random sequence of IEEE 802.16m, for example. At this point, a seed value for generating a random sequence may be determined according to a subframe index.

Next, in order to obtain a frequency diversity gain, a method for uniformly distributing a plurality of mini-tiles constituting each supplementary subchannel in a frequency domain and mapping them will be described.

A supplementary subchannel may be allocated to a different slot than the slot to which a corresponding dedicated subchannel is allocated. For example, if dedicated subchannel index 1 is allocated to slot 1, the corresponding supplementary subchannel index C1 may be allocated to slot 2.

To map mini-tiles of the supplementary subchannel, a modulo operation may be used. For example, mapping can be done so as to satisfy (mod((mini-tile index−1), 9)+1)=(mod(j−1, 9)+1). Here, j indicates the index of a slot to which a dedicated subchannel corresponding to a supplementary subchannel is allocated. FIG. 28 suggests a method for mapping a supplementary subchannel.

In the above, a frame structure in which resources for direct communication between terminals are allocated has been described. That is, the resources for direct communication between terminals may include at least one of a synchronization channel, a dedicated channel, and a supplementary channel. The synchronization channel, the dedicated channel, and the supplementary channel may be mapped according to the above-described method. As dedicated subchannels and supplementary subchannels correspond one-to-one, the operation complexity and power consumption of a terminal can be reduced merely by decoding the supplementary subchannels without decoding the entire packet.

Now, the operation of a terminal using resources for direct communication between terminals will be described.

First, the operation of a terminal on standby for communication will be described.

The terminal on standby for communication acquires frequency synchronization and time synchronization by correlation operation of an SCH-sequence of a synchronization channel, and acquires information about a terminal that has transmitted the synchronization channel, hop count information, frame structure information, etc., by decoding an SCH_message.

Also, the terminal on standby for communication decodes a supplementary subchannel, and monitors if there is an RTS transmitted to the corresponding terminal designated as a receiving terminal. If necessary, the terminal may undergo the process of decoding an RTS message included in the dedicated subchannel corresponding to the supplementary subchannel.

If the terminal on standby for communication receives RTS, it transmits CTS and information required for synchronization acquisition and link setup through a supplementary subchannel of the next superframe and the corresponding dedicated subchannel.

Afterwards, the terminal on standby for communication decodes data received through the dedicated subchannel, and transmits at least one of control information, PHY signaling, and feedback information in order to perform direct communication through the corresponding supplementary subchannel.

Next, the operation of the terminal on standby for communication will be described.

The terminal on standby for communication acquires frequency synchronization and time synchronization by correlation operation of an SCH-sequence of a synchronization channel. If no effective synchronization channel is received, the terminal may transmit SCH_sequence. Also, the terminal on standby for communication acquires information about a terminal that has transmitted the synchronization channel, hop count information, frame structure information, etc., by decoding an SCH_message.

Moreover, the terminal on standby for communication monitors the power levels of dedicated subchannels, and acquires information about available dedicated subchannels by decoding the supplementary channel.

If a desired dedicated subchannel is empty, the terminal on standby for communication transmits a first RTS message through a corresponding supplementary subchannel, and if necessary, transmits a second RTS message and a signal required for synchronization acquisition through a dedicated subchannel. If the terminal on standby for communication wants to use two or more dedicated subchannels at a time, it may transmit the dedicated subchannels independently.

After a predetermined length of time, the terminal on standby for communication monitors CTS reception. Upon receipt of CTS, the terminal may transmit a packet through a dedicated subchannel.

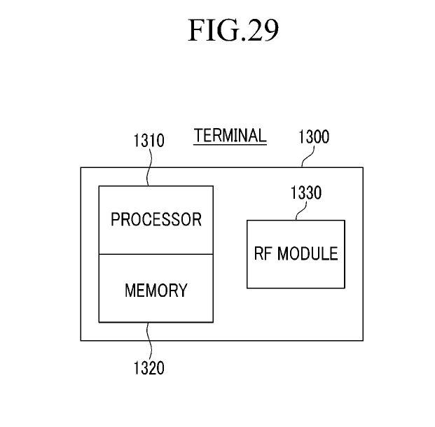

FIG. 29 illustrates a terminal applicable to an exemplary embodiment of the present invention.

Referring to FIG. 29, a terminal 1300 includes a processor 1310, a memory 1320, and a radio frequency (RF) unit 1330. The processor 1310 may be configured to implement the procedures and/or methods suggested in the present invention. The memory 1320 stores various information connected with the processor 1310 and related to the operation of the processor 1310. The RF unit 1330 is connected to the processor 1310, and sends and/or receives a radio signal. The terminal 1300 may have a single antenna or multiple antennas.

According to an exemplary embodiment of the present invention, a method for allocating resources for direct communication between terminals can be obtained. Therefore, a terminal located outside a cell coverage, as well as a terminal located within the cell coverage, can perform direct communication by using resources allocated fixedly for direct communication between terminals. Moreover, the efficiency of resource utilization can be improved by adaptively adjusting the amount of resources allocated for direct communication between terminals according to demand for direct communication between terminals.

According to another exemplary embodiment of the present invention, a method for mapping resources for direct communication between terminals on a frame can be obtained. Accordingly, data retransmission delay during direct communication between terminals can be reduced, and a frequency diversity gain can be obtained.

The above-described exemplary embodiments of the present invention are not only realized by methods and apparatuses, but, on the contrary, are intended to be realized by a program for realizing functions corresponding to the configuration of the exemplary embodiments of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a first terminal to perform direct communication between terminals, the method comprising
performing direct communication with at least one second terminal by using resources allocated for direct communication between terminals,
the resources comprising a common direct mode zone which is commonly allocated to all cells and has a fixed size and position.

2. The method of claim 1, wherein the resources further comprise a cell-specific direct mode zone which is allocated to each cell.

3. The method of claim 2, wherein information about the cell-specific direct mode zone is acquired through the common direct mode zone.

4. The method of claim 1, wherein the common direct mode zone is allocated to part of an uplink area of resources allocated for cellular communication.

5. The method of claim 1, wherein the common direct mode zone is allocated to four contiguous PRUs (physical resource units).

6. The method of claim 5, wherein the four contiguous PRUs have the four highest PRU indices.

7. The method of claim 1, wherein a basic unit of the common direct mode zone comprises a plurality of resource blocks.

8. The method of claim 7, wherein the plurality of resource blocks are distributed in a frequency domain.

9. The method of claim 1, wherein the resources further comprise a common direct mode zone extended which is commonly allocated to all cells and has a fixed size and position.

10. The method of claim 9, wherein the common direct mode zone extended is allocated to part of a downlink area of resources allocated for cellular communication.

11. A method for a first terminal to perform direct communication between terminals, the method comprising
performing direct communication with at least one second terminal by using resources allocated for direct communication between terminals,
wherein the resources comprise a first slot region and a second slot region,
the first slot region comprising at least one of a synchronization channel containing synchronization information for direct communication between terminals, a dedicated channel for transmitting direct communication data between terminals, and a supplementary channel one-to-one mapped with the dedicated channel, the second slot region comprising the dedicated channel and the supplementary channel.

12. The method of claim 11, wherein the synchronization channel comprises a first region for transmitting information for acquiring frequency synchronization and time synchronization, and a second region for transmitting at least one of hop count information, base station information, transmitting terminal information, receiving terminal information, and frame structure information.

13. The method of claim 11, wherein the supplementary channel transmits at least one of an indicator of a MAC message, PHY signaling, and a feedback message.

14. The method of claim 11, wherein the dedicated channel comprises a plurality of dedicated subchannels, the supplementary channel comprises a plurality of supplementary subchannels, and each of the dedicated subchannels is one-to-one mapped with each of the supplementary subchannels.

15. The method of claim 14, wherein
a supplementary subchannel corresponding to a dedicated subchannel allocated to the first slot region is allocated to the second slot region, and
a supplementary subchannel corresponding to a dedicated subchannel allocated to the second slot region is allocated to the first slot region.

16. A method for a first terminal to perform direct communication between terminals, the method comprising
performing direct communication with at least one second terminal by using resources allocated for direct communication between terminals,
wherein the resources are included in a resource area comprising a plurality of superframes, each superframe comprising a plurality of frames, each frame comprising a plurality of subframes,
wherein a synchronization channel containing synchronization information for direct communication between terminals, a dedicated channel for transmitting direct communication data between terminals, and a supplementary channel one-to-one mapped with the dedicated channel is respectively allocated to the subframes.

17. The method of claim 16, wherein
each superframe comprises a first slot region and a second slot region,
the first slot region comprising at least one of the synchronization channel, the dedicated channel, and the supplementary channel, and the second slot region comprising the dedicated channel and the supplementary channel.

18. The method of claim 17, wherein the first subframe of the first slot region is allocated to the synchronization channel.

19. The method of claim 17, wherein the dedicated channel is allocated in units of dedicated subchannels, each comprising a plurality of resource blocks, and the supplementary channel is allocated in units of supplementary subchannels, each comprising a plurality of mini-tiles.

20. The method of claim 19, wherein
a dedicated subchannel allocated to the first slot region is mapped with one of the supplementary subchannels allocated to the second slot region, and
a dedicated subchannel allocated to the second slot region is mapped with one of the supplementary subchannels allocated to the first slot region.

21. The method of claim 19, wherein a plurality of resource blocks constituting the dedicated subchannel are distributed in a frequency domain, and a plurality of mini-tiles constituting the supplementary subchannel are distributed in a frequency domain.

22. The method of claim 21, wherein the plurality of resource blocks constituting the dedicated subchannel are distributed in the frequency domain according to a cyclic shift or permutation sequence.

23. The method of claim 21, wherein the plurality of mini-tiles constituting the supplementary subchannel are distributed in the frequency domain according to a result of a modulo operation of the mini-tile indices.
